(19) United States
(12) Patent Application Publication
(10) Pub. No.: US 2020/0361107 A1
(43) Pub. Date: Nov. 19, 2020

(54) RAZOR

(71) Applicant: Seung-Bok PARK, Incheon (KR)

(72) Inventor: Seung-Bok PARK, Incheon (KR)

(21) Appl. No.: 16/307,542

(22) PCT Filed: Oct. 19, 2017
(86) PCT No.: PCT/KR2017/011619

§ 371 Date: Dec. 6, 2018

(51) Int. Cl. B26B 21/52; B26B 21/40

(52) U.S. Cl. CPC B26B 21/521; B26B 21/225; B26B 21/4012

(57) ABSTRACT

The present invention provides a razor. A body has blade protrusion holes provided in an outer circumferential surface thereof in both directions. A handle unit is configured such that one end of the body is fitted thereinto, and guides the body to a location in which the body is to be accommodated. A blade holder is inserted into the body and guiding coupling of blades such that the blades protrude from the body at different lengths.

### TECHNICAL FIELD

The present invention relates to a razor enabling selective shaving to be performed depending on the length of body hair or facial hair, as well as bidirectional shaving.

### BACKGROUND ART

In general, a razor is provided with blades to be used to cut body hair or facial hair.

As illustrated in FIG. 5, such a razor 10 includes a cartridge 20, a connector 30, and a handle unit 40. The cartridge 20 is provided with a blade 21, by which a user can cut body hair or facial hair.

The handle unit 40 is a portion that the user holds with a hand to properly shave. The handle unit 40 is provided with holding hooks 41, by which the connector 30 can be selectively attached to and detached from the handle unit 40.

In addition, the connector 30 is a component connecting the handle unit 40 and the cartridge 20. Coupling recesses (not shown) are provided in one end of the connector 30, allowing the holding hooks 41 of the handle unit 40 to be fixedly fitted thereto. Pivot supports 31 are provided on the other end of the connector 30 to be fitted into pivot guides 22 of the cartridge 20.

However, such a razor 10 is configured such that not only the coupling structure between the cartridge 20 and the connector 30 is complicated, but also the user can shave only in a single direction by grasping the handle unit 40. Since the entirety of the cartridge 20 must be replaced to replace the blade 21, additional expense is incurred.

In addition, since one edge of the blade 21 is configured to be in line contact at an inclined angle with the skin, carelessness during shaving may cause the user to be cut by the edge of the blade 21. Since the blade 21 is typically made of steel, it is difficult for the blade 21 to maintain good affinity to the skin.

In addition, it is highly probable that the steel blade 21 may be contaminated or deteriorated by oxidation due to frequent contact with moisture or air during use. In severe cases, the blade may easily rust and must be replaced frequently, which is problematic.

### DISCLOSURE

### Technical Problem

Accordingly, the present invention has been made keeping in mind the above problems occurring in the prior art, and an object of the present invention is to provide a razor in which edges of blades to be in direct contact with the skin protrude from both sides at different lengths, such that selective shaving can be performed depending on the length of body hair or facial hair or shaving can be performed in both directions. In addition, since the blades are made of a ceramic material, it is possible to reduce the frequency of replacement of the blades.

### Technical Solution

In order to accomplish the above object, the present invention provides a razor including: a body having blade protrusion holes provided in an outer circumferential surface thereof in both directions; a handle unit configured such that one end of the body is fitted thereinto, and guiding the body to a location in which the body is to be accommodated; and a blade holder inserted into the body and guiding coupling of blades such that the blades protrude from the body at different lengths.

The body may include: an insert member inserted into the handle unit and providing top and side portions of the body; and a body member such that the insert member extends through a central portion thereof, accommodating the blade holder therein and coupled to the insert member to define the blade protrusion holes, and providing a bottom portion of the body.

The body member may have elongated discharge holes downwardly spaced apart from the blade protrusion holes to allow hair cut by the blades and introduced into the body member to be discharged.

The blade holder may include: a first coupling member inserted into the body; and a second coupling member provided on top of the first coupling member to define a pair of coupling areas to which the blades are attached.

The blades may be a pair of blades having different lengths, attached to the coupling areas, and protruding from the body through the blade protrusion holes at different lengths.

The handle unit may include: a handle configured such that the body is fitted thereinto; and a connection guide coupled to an outer circumferential surface of the handle to rotate independently of the handle to guide the body fitted thereinto to move downwards in a longitudinal direction.

The blades may be made of a ceramic material.

### Advantageous Effects

According to the present invention, the edges of the blades to be in direct contact with the skin protrude from both sides at different lengths. When the hair of the user is relatively short, shaving is performed using the blade protruding at the relatively shorter length. In contrast, when the hair of the user is relatively long, shaving is performed using the blade protruding at the relatively longer length. In this manner, selective shaving can be performed depending on the length of body hair or facial hair.

In addition, according to the present invention, the blades protrude from both sides of the body unit, such that shaving can be performed in both directions.

Furthermore, according to the present invention, the blades are made of a ceramic material in order to overcome the problem in that the blades are polluted or deteriorated by oxidation due to frequent contact with moisture or air during use. It is therefore possible to reduce the frequency of replacement of the blades.

### DESCRIPTION OF DRAWINGS

FIG. 1 is an exploded view illustrating a razor according to an embodiment of the present invention;

FIG. 2 is an assembled view illustrating the razor according to the embodiment of the present invention;

FIG. 3 is a view illustrating a process of assembling the razor according to the embodiment of the present invention;

FIG. 4 is a cross-sectional view illustrating the blades protruding from the razor, as well as the internal structure of the razor, taken along line A-A′ in FIG. 2; and

FIG. 5 is a schematic view illustrating a razor of the related art.

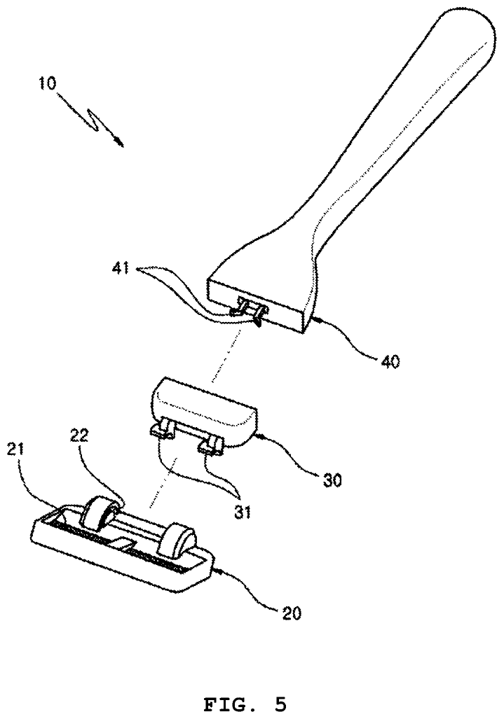

### MODE FOR INVENTION

Hereinafter, exemplary embodiments of the present invention will be described in detail with reference to the accompanying drawings.

Advantages and features of the present invention, as well as methods of realizing the same, will be more clearly understood from the following detailed description when taken in conjunction with the accompanying drawings.

The present disclosure may, however, be embodied in many different forms and should not be construed to be limited to the embodiments set forth herein. Rather, these embodiments are provided so that the present disclosure will be thorough and complete, and will fully convey the scope of the invention to those skilled in the art. The scope of the present disclosure shall only be defined by the appended Claims.

Detailed descriptions of known functions and components incorporated herein will be omitted in the case that the subject matter of the present disclosure may be rendered unclear thereby.

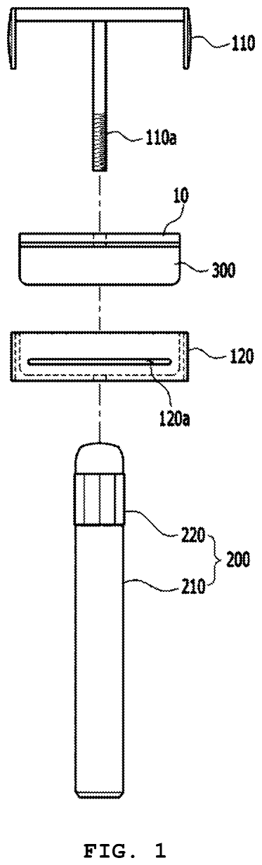

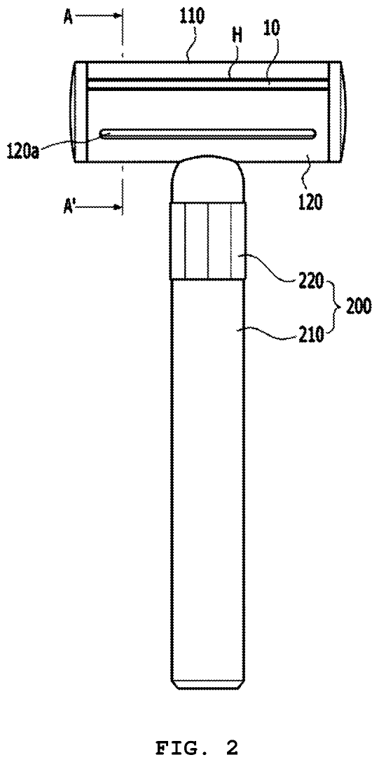

FIG. 1 is an exploded view illustrating a razor according to an embodiment of the present invention, and FIG. 2 is an assembled view illustrating the razor according to the embodiment of the present invention.

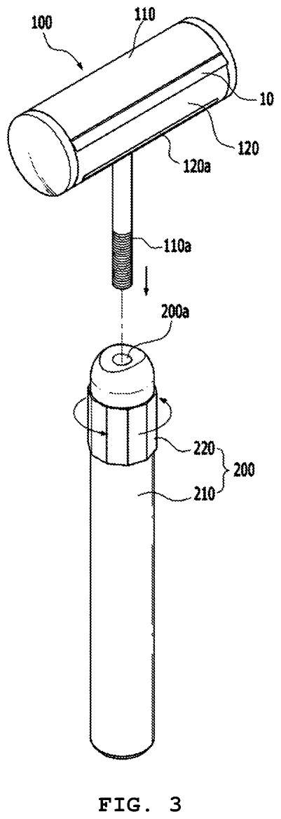

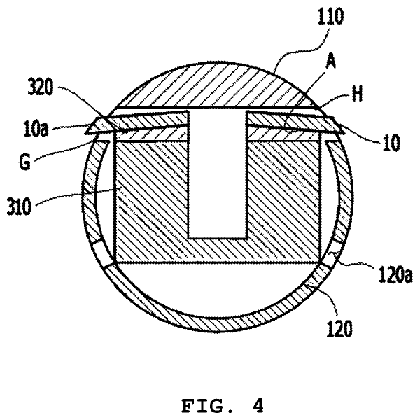

In addition, FIG. 3 is a view illustrating a process of assembling the razor according to the embodiment of the present invention, and FIG. 4 is a cross-sectional view illustrating the blades protruding from the razor, as well as the internal structure of the razor, taken along line A-A′ in FIG. 2.

As illustrated in FIGS. 1 and 2, the razor according to the present embodiment includes a body 100, a handle unit 200, and a blade holder 300.

The body 100 has a T-shaped configuration, with an outer circumferential surface thereof to be in contact with the skin being rounded. In addition, blade protrusion holes H are provided in the outer circumferential surface of the body 100 in both directions.

Specifically, the top portion of the body 100 is cylindrically shaped, and the blade protrusion holes H laterally extending at a predetermined length in the top portion of the body 100 such that blades 10 and 10a protrude outwards through the blade protrusion holes H when the blade holder 300 is fitted into the top portion of the body 100.

In this regard, the body 100 includes an insert member 110 and a body member 120.

First, the insert member 110 is T-shaped, is inserted into the handle unit 200, and has rounded top and side portions, i.e. forms the top and side portions of the cylindrical body 100.

The insert member 110 has a T-shaped fastening bar 110a having threads on an outer circumferential surface thereof. In a position in which the blade holder 300 and the body member 120 are sequentially connected to the insert member 110 such that the fastening bar 110a extends through the blade holder 300 and the body member 120, the threads of the fastening bar 110a may be inserted into and screw-engaged with the interior of the handle unit 200.

The body member 120 is shaped to surround outer surfaces of the body member 120 accommodated therein. More particularly, the body member 120 may have a semicircular shape to define the rounded outer circumferential surface together with the insert member 110.

Specifically, the body member 120 is shaped to surround the body member 120 while surrounding the lower portion of the blade holder 300 having a predetermined height. In a position in which the body member 120 is connected to the insert member 110, the blade protrusion holes H are provided in the outer surface to be opened in both directions.

Here, the blade protrusion holes are provided in the body 100 in both directions, respectively. When the blade holder 300 is placed within and connected to the body 100, the blades 10 and 10a protrude outward through the blade protrusion holes, such that shaving can be performed in both directions.

The body member 120 is provided with a pair of elongated discharge holes 120a. The discharge holes 120a are downwardly spaced apart from the blade protrusion holes. The discharge holes 120a guide hair, such as body hair or facial hair, introduced into the body member 120 after being cut by the blades 10 and 10a, to be discharged.

In other words, as illustrated in FIG. 4, gaps G are provided between the blades 10 and 10a and the body member 120 due to differences in height therebetween when the blade holder 300 is connected to the body member 120. When hair cut during shaving enters the body 100 through the gaps G, the hair is discharged through the discharge holes 120a without staying within the body 100.

The handle unit 200 having a predetermined length is configured such that one end of the body 100 can be fitted thereinto, and is configured to guide the body 100 to a location in which the body 100 is to be accommodated.

The handle unit 200 is portion to be gripped by the user, and although not shown in the drawings, may be provided with an anti-slip member in the longitudinal direction thereof, the anti-slip member being made of rubber or the like to ensure that the user can grip the handle unit 200 without slipping.

The handle unit 200 includes a handle 210 and a connection guide 220.

The handle 210 is configured such that the body 100, more particularly, the fastening bar 110a of the body 100 perpendicularly protruding from the top portion of the body 100 at a predetermined length, is fitted thereinto.

In addition, the connection guide 220 is coupled to the outer circumferential surface of the handle 210 to rotate independently of the handle 210, and has threads in an inner circumferential surface thereof. The threads correspond to the threads of the body 100, i.e. the threads on the fastening bar 110a.

Accordingly, when the fastening bar 110a is inserted into a fastening hole 200a to be situated within the handle 210, the connection guide 220 can rotate independently of the handle 210, as illustrated in FIG. 3, thereby guiding the body 100 screw-engaged therewith via the fastening bar 110a to move down in the longitudinal direction while being engaged therewith.

As described above, when the connection guide 220 is screw-engaged with the fastening bar 110a, it is possible to easily connect and disconnect the body 100 to and from the handle unit 200 by only rotating the connection guide 220. Accordingly, the connection guide 220 can contribute to simplification of a connection structure of the razor.

In addition, the blade holder 300 is inserted into the body 100, and guides coupling of the blades 10 and 10a such that the blades 10 and 10a protrude from the body 100 at different lengths.

The blade holder 300 includes a first coupling member 310 and a second coupling member 320.

The first coupling member 310 is inserted into the body 100, and although not shown in the drawings, has a guide hole in a central portion thereof, through which the fastening bar 110a can extend for screw engagement with the handle unit 200.

The second coupling member 320 is provided on top of the first coupling member 310 to define a pair of coupling areas A to which the blades 10 and 10a are attached.

The coupling areas A have predetermined inclinations, allowing the blades 10 and 10a to protrude from the body 100 through the blade protrusion holes in downwardly-inclined directions.

Here, as illustrated in FIG. 4, the blades 10 and 10a are provided as a pair of blades having different lengths, are attached to the coupling areas A, respectively, and protrude from the body 100 through the blade protrusion holes by different lengths.

More specifically, one blade 10 protruding at a shorter length protrudes with a length difference of about 0.1 mm with respect to the length of the other blade 10a. This difference in length is not fixed and may be set in the manufacture of the blades 10 and 10a as required.

Accordingly, the razor according to the present embodiment has the blade protrusion holes provided in both directions of the body 100, such that shaving can be performed in both directions. In addition, since the blades 10 and 10a protrude through the blade protrusion holes at different lengths during shaving, selective shaving can be performed depending on the preference or purpose of the user.

For example, when the hair of the user is relatively short, the user may perform shaving using the blade 10 protruding at the shorter length. When the hair of the user is relatively long, the user may perform shaving using the blade 10a protruding at the longer length. Accordingly, it is possible to perform shaving in both directions and in an efficient manner.

The blades 10 and 10a of the razor according to the present embodiment may be made of a ceramic material. In the related art, blades are typically made of steel. However, the steel blades may not be able to maintain skin affinity when in contact with the skin. In addition, it is highly probable that the steel blades may be contaminated or deteriorated by oxidation due to frequent contact with moisture or air during use. In severe cases, the blades may easily rust and must be replaced frequently. Accordingly, the blades 10 and 10a may be made of the ceramic material in order to effectively overcome such problems.

According to the present invention, the edges of the blades to be in direct contact with the skin protrude from both sides at different lengths. When the hair of the user is relatively short, shaving is performed using the blade protruding at the relatively shorter length. In contrast, when the hair of the user is relatively long, shaving is performed using the blade protruding at the relatively longer length. In this manner, selective shaving can be performed depending on the length of body hair or facial hair.

In addition, according to the present invention, the blades protrude from both sides of the body, such that shaving can be performed in both directions.

Furthermore, according to the present invention, the blades are made of a ceramic material in order to overcome the problem in that the blades are polluted or deteriorated by oxidation due to frequent contact with moisture or air during use. It is therefore possible to reduce the frequency of replacement of the blades.

In the foregoing detailed description, the present invention has been described with respect to the specific embodiments thereof. However, those skilled in the art will appreciate that the present invention is by no means limited to the above-stated specific forms and a variety of modifications can be made therefrom by selectively combining all or portions of the foregoing embodiments. It should be understood that the scope of the present invention shall be defined by the appended Claims.

### DESCRIPTION OF THE REFERENCE NUMERALS IN THE DRAWINGS

| | |
|---|---|
| 10, 10a: | Blade |
| 100: | Body |
| 110: | Insert member |
| 110a: | Fastening bar |
| 120: | Body member |
| 120a: | Discharge hole |
| 200: | Handle unit |
| 200a: | Fastening hole |
| 210: | Handle |
| 220: | Connection guide |
| 300: | Blade holder |
| 310: | First coupling member |
| 320: | Second coupling member |
| A: | Coupling area |
| H: | Blade protrusion hole |
| G: | Gap |

What is claimed is:

1. A razor comprising:
a body having blade protrusion holes provided in an outer circumferential surface thereof in both directions;
a handle unit configured such that one end of the body is fitted thereinto, and guiding the body to a location in which the body is to be accommodated; and
a blade holder inserted into the body and guiding coupling of blades such that the blades protrude from the body at different lengths.

2. The razor according to claim 1, wherein the body comprises:
an insert member inserted into the handle unit and providing top and side portions of the body; and
a body member such that the insert member extends through a central portion thereof, accommodating the blade holder therein and coupled to the insert member to define the blade protrusion holes, and providing a bottom portion of the body.

3. The razor according to claim 2, wherein the body member has elongated discharge holes downwardly spaced apart from the blade protrusion holes to allow hair cut by the blades and introduced into the body member to be discharged.

4. The razor according to claim 1, wherein the blade holder comprises:
a first coupling member inserted into the body; and
a second coupling member provided on top of the first coupling member to define a pair of coupling areas to which the blades are attached.

5. The razor according to claim 4, wherein the blades comprise a pair of blades having different lengths, attached to the coupling areas, and protruding from the body through the blade protrusion holes at different lengths.

6. The razor according to claim 1, wherein the handle unit comprises:
a handle configured such that the body is fitted thereinto; and
a connection guide coupled to an outer circumferential surface of the handle to rotate independently of the handle to guide the body fitted thereinto to move downwards in a longitudinal direction.

7. The razor according to claim 1, wherein the blades are made of a ceramic material.
